(19) United States
(12) Patent Application Publication
(10) Pub. No.: US 2017/0200211 A1
(43) Pub. Date: Jul. 13, 2017

(54) KNOWLEDGE PROCESSING METHODS AND APPARATUSES FOR APPLYING REASONING TECHNIQUES BASED ON BROWSING DATA INTEGRATED AS A COLLECTION OF FACTS AND RELATIONSHIPS

(71) Applicant: ALIBABA GROUP HOLDING LIMITED, George Town, Grand Cayman (KY)

(72) Inventor: Shuyan LIU, Hangzhou (CN)

(21) Appl. No.: 15/325,394

(22) PCT Filed: Jun. 17, 2015
(86) PCT No.: PCT/CN2015/081664

§ 371 Date: Jan. 10, 2017

(30) Foreign Application Priority Data
Jul. 11, 2014 (CN) 201410331630.7

(51) Int. Cl. G06Q 30/06; G06Q 10/10

(52) U.S. Cl. CPC G06Q 30/0619; G06Q 10/1093

(57) ABSTRACT

The present application discloses methods and apparatuses for providing information about target commodities. An exemplary method may include establishing in advance correspondence between information about living scenarios and associated target commodities. The method may also include monitoring a browsing behavior of a user. In addition, the method may include determining information about a living scenario of the user when the monitored browsing behavior satisfies a first characteristic. Moreover, the method may include determining information about target commodities associated with the information about the living scenario. Furthermore, the method may include providing the determined information about the target commodities to the user. The present application may effectively guide users through reasonable utilization of services or resources provided by a transaction platform while reminding users about daily schedule activities.

### CROSS REFERENCE TO RELATED APPLICATION

This application is the U.S. national stage application under 35 U.S.C. §371 of International Application No. PCT/CN2015/081664, filed on Jun. 17, 2015, which claims priority to and the benefits of priority to Chinese Application No. 201410331630.7, filed Jul. 11, 2014, the entire contents of which have been incorporated herein by reference.

### TECHNICAL FIELD

The present application relates to the technology field of information processing for target commodities, and more particularly, to methods and apparatuses for providing information about target commodities.

### BACKGROUND

With the constant improvement of e-commerce transaction platforms and the rapid development of conventional communications and mobile communications technologies, more and more people choose to acquire commodities they need by online shopping. The categories of commodities cover various aspects in daily life. When shopping through such an e-commerce transaction platform, people are often attracted by colorful contents of web pages and unconsciously browse a lot of the contents. However, practically, the browsing requires people to focus their attention and is quite energy consuming. They do not feel tired until they stop browsing. In addition, people frequently forget the time for dinner or sleep in this situation. Their daily schedules are disrupted. It may cause an adverse effect on health. Moreover, after users browse target commodities under one category, the percentage that final deals are made is not high. Instead, services that are really useful for users cannot be found and fully utilized by users.

Therefore, how to effectively guide users through reasonable utilization of services or resources provided by a transaction platform while reminding users about daily schedule activities has become a technical problem that those skilled in the art need to solve.

### SUMMARY

The present application provides methods and apparatuses for providing information about target commodities. It may effectively guide users through reasonable utilization of services or resources provided by a transaction platform while reminding users about daily schedule activities.

In one aspect, the present disclosure is directed to a method for providing information about target commodities. The method may include establishing in advance correspondence between information about living scenarios and associated target commodities. The method may also include monitoring a browsing behavior of a user. In addition, the method may include determining information about a living scenario of the user when the monitored browsing behavior satisfies a first characteristic. Moreover, the method may include determining information about target commodities associated with the information about the living scenario. Furthermore, the method may include providing the determined information about the target commodities to the user.

In another aspect, the present disclosure is directed to an apparatus for providing information about target commodities. The apparatus may include a correspondence establishing unit establishing in advance correspondence between information about living scenarios and associated target commodities. The apparatus may also include a monitoring unit monitoring browsing behavior of a user. The apparatus may further include a living-scenario-information determining unit determining information about a living scenario of the user when the monitored browsing behavior satisfies a first characteristic. In addition, the apparatus may include a target-commodity-information determining unit determining information about target commodities associated with the information about the living scenario. Moreover, the apparatus may also include a target-commodity-information providing unit providing the determined information about the target commodities to the user.

According to specific embodiments in the present application, the present application discloses the following technical effects:

Through the embodiments of the present application, a browsing behavior of a user in a transaction platform may be monitored. When it is detected that the browsing behavior satisfies a first characteristic, information about a living scenario of the user may further be acquired. Accordingly, information about target commodities associated with the information about the living scenario is recommended to the user. In this way, on one hand, the user is freed from the previous browsing behavior and can relax his attention. On the other hand, since the recommended information is closely related to the actual living scenario of the user, an effect of reminding the user of daily schedule is also achieved. From the perspective of the transaction platform, because the recommended information is useful to the user, there is a high probability that the user makes a deal. In other words, the probability of effective utilization of services or resources in the transaction platform is increased.

Any product implementing the present application does not necessarily achieve all of the above-mentioned advantages simultaneously.

### BRIEF DESCRIPTION OF THE DRAWINGS

To describe the technical solutions in the embodiments of the present application or the prior art clearly, the drawings that need to be used in the descriptions of the embodiments will be briefly introduced below. It is obvious that the drawings in the following description are merely some embodiments of the present application. Those of ordinary skill in the art may further obtain other drawings according to these drawings without creative efforts.

FIG. 1 is a flowchart of an exemplary method for providing information about target commodities, according to an embodiment of the present application.

FIG. 2 is a schematic diagram of an apparatus method for providing information about target commodities, according to an embodiment of the present application.

### DETAILED DESCRIPTION

The technical solutions in the embodiments of the present application will be clearly and fully described below with reference to the accompanying drawings in the embodiments of the present application. It is obvious that the described embodiments are merely some, rather than all, embodiments of the present application. All other embodiments obtained by those of ordinary skill in the art based on the embodiments of the present application fall within the protection scope of the present application.

In the embodiments of the present application, user behaviors in a transaction platform may be monitored in an Internet environment. If it is detected that a browsing behavior of a user satisfies a particular characteristic and the user is in a particular and stored preset living scenario, information about target commodities related to the stored living scenario may be recommended to the user. In this way, on one hand, the user can shift his/her attention from the previous browsing behavior that has lasted for a long time to the recommended information. On the other hand, since the recommended information is related to the stored preset living scenario of the user, it can remind the user of things to be done based on the stored living scenario. Moreover, the recommended information about the target commodities is related to the things that the user needs to do according to the stored and preset living scenario. It is also equivalent to guiding the user to pay attention to services or resources that he or she most possibly needs at present based on previous user activity. Accordingly, the services or resources can be utilized, thereby realizing their value. Practical implementations are described in detail below.

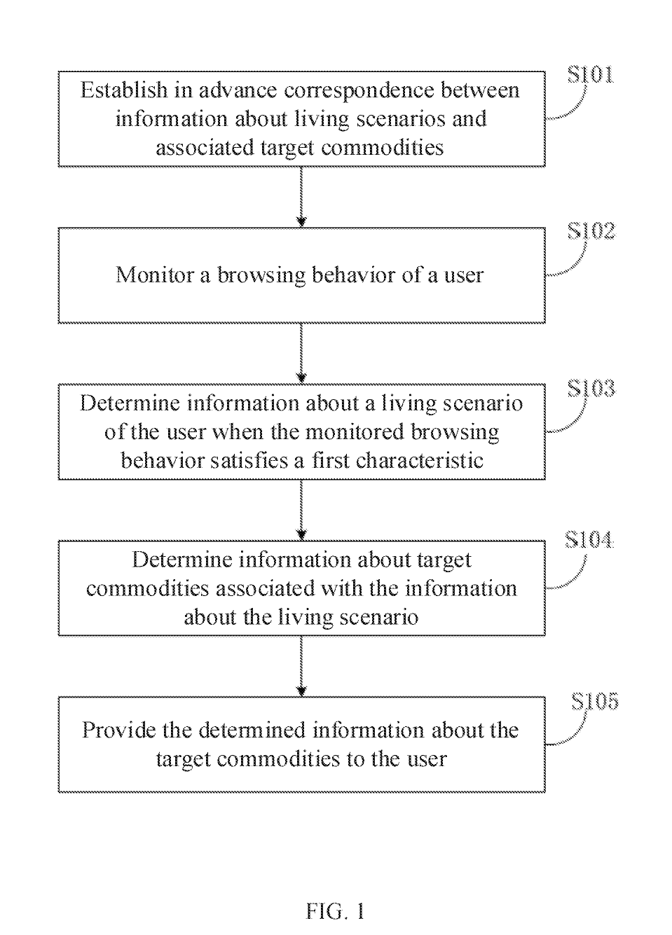

Referring to FIG. 1, an embodiment of the present application first provides a method for providing information about target commodities. The method may include the following steps:

S101: Establish in advance correspondence between information about living scenarios and associated target commodities.

In a specific implementation, target commodities that a transaction platform can provide may cover various aspects of daily life. Some target commodities may exist in the form of services or resources. Such services or resources may be directly related to a living scenario of a user. For example, when needing to have lunch, the user may search the transaction platform for restaurants that offer promotions of group purchase and so forth. When needing to conduct a recreational or entertainment activity, the user may search the transaction platform for places of entertainment that offer promotions of group purchase and so forth. Therefore, in this embodiment of the present application, correspondence between information about living scenarios and information about associated target commodities may be established in advance. In this way, when it is found that the user has been idling about in the transaction platform for a long time, and a criterion of a particular living scenario is met, information about target commodities corresponding to the living scenario can be recommended to the user. Therefore, the user can shift from the previous idling state to a state related to the recommended target commodities. In addition, because the recommended target commodities are related to the living scenario of the user, it not only can guide the user to acquire a service corresponding to the recommended information, but also can remind the user of going back to the real world to do things that need to be done in the living scenario. For example, if it is time for lunch when the user is browsing, the user should have lunch first. Accordingly, target commodities related to lunch are recommended to the user, such as information about group purchase of restaurants, or information about restaurants that can provide take-away services.

In a specific implementation, the correspondence between information about living scenarios and information about target commodities may be stored as shown in Table 1.

TABLE 1

| Information about | |
|---|---|
| Living Scenario | Information about Target Commodities |
| Breakfast | Information about breakfasts |
| Lunch | Information about group purchase of |
| | lunch at a restaurant |
| Afternoon Tea | Information about group purchases of one |
| | kind of snack foods |
| Dinner | Information about group purchases of |
| | dinner |
| Fitness | Information about cosmetology |
| . . . | . . . |

S102: Monitor a browsing behavior of a user.

When the user enters a client interface of the transaction platform and performs a browsing behavior, the transaction platform system can perceive the times at which the user enters and leaves the transaction platform. The transaction platform system can also learn behaviors that are performed by the user, specific web pages that the user has browsed, and so on. Therefore, the transaction platform may start timing when the user enters the transaction platform, and stops timing when finding that the user leaves the transaction platform. For example, if a user enters the transaction platform and does not leave the transaction platform for a particular period of time (for example, 1 hour or longer), it is deemed that a continuous browsing behavior of the user in the transaction platform is detected.

It should be noted that in this embodiment of the present application, the so-called monitoring of the browsing behavior of the user may refer to acquiring the browsing behavior by monitoring information generated by a client. When the user performs various browsing behaviors, a browser client or an application client needs to be used. The client submits various requests to a server, acquires various responses from the server, and then displays the responses through a user interface of the client. Therefore, according to various request messages generated by the clients, corresponding information about browsing behavior can be acquired and monitored.

S103: Determine information about a living scenario of the user when the monitored browsing behavior satisfies a first characteristic;

After it is detected that a browsing behavior of a user satisfies a preset characteristic, information about a living scenario of the user may be acquired. There may be multiple first characteristics. For example, in practical applications, the first characteristic may include at least one or any combination of the following browsing behavior characteristics: an accumulated time of a browsing behavior of the user starting from a particular start time point (for example, starting from 0:00 of the day) exceeds a first time threshold; a time length of a continuous browsing behavior of the user exceeds the first time threshold; or a time length of a browsing behavior of the user on at least one specified website (which may include an accumulated time length starting from a particular start time point, or a time length of a duration of one time of browsing) exceeds the first time threshold.

The so-called information about the living scenario refers to which activity the user should or may perform at this time point in his or her real life, such as meals (which may be further identified as breakfast, lunch, and dinner), afternoon tea, and cosmetology. Therefore, the information about the living scenario may specifically be acquired based on information in various aspects such as time and location.

For example, when it is detected that a user performs a browsing behavior that satisfies the first characteristic, the current time point may be acquired. If the current time point falls within a preset time slot, it may be determined that information about a living scenario corresponding to the pre-set time slot is acquired. Correspondence between time slots and information about living scenarios may be established in advance according to empirical correspondence. For example, in general, a living scenario corresponding to 7:00 to 9:00 in the morning may be breakfast. A living scenario corresponding to 11:30 to 13:00 may be lunch. A living scenario corresponding to 15:00 to 16:30 may be afternoon tea. A living scenario corresponding to 17:30 to 19:30 may be dinner. In a specific implementation, such correspondence may be stored in advance in a database. For example, information in the database may be as shown in Table 2.

TABLE 2

| Time Slots | Information about Living Scenarios |
|---|---|
| 7:00-9:00 | Breakfast |
| 11:30-13:00 | Lunch |
| 15:00-16:30 | Afternoon Tea |
| 17:30-19:30 | Dinner |
| . . . | . . . |

When it is found that a user performs a browsing behavior that satisfies the first characteristic and the current time point exactly falls within a particular time slot, information about the corresponding living scenario may be acquired by querying the database shown in Table 2. For example, when it is found at 12:00 that a user has been browsing in the transaction platform for a long time, it may be learned by querying the database shown in Table 2 that the information about the living scenario of the user is “lunch.” In other words, it is time for lunch.

The time slots and the information about the corresponding living scenarios as shown in the above-mentioned Table 2 are generally obtained through statistics based on common habits of most people. However, in practical applications, different users may have different daily schedules. For example, a user whose work is special may set the lunch time to 14:00 to 15:00 and correspondingly set the dinner time to 19:00 to 21:00. The user may not have the habit of drinking afternoon tea, and so on. Therefore, in a specific implementation, information about respective daily schedules of users may be acquired individually. In this case, different information databases of living scenarios may be established for different users. For example, in this case, information recorded in the database may be as shown in Table 3.

TABLE 3

| User Identity | Time Slots | Information about Living Scenarios |
|---|---|---|
| User 1 | 7:00-9:00 | Breakfast |
| | 11:30-13:00 | Lunch |
| | 15:00-16:30 | Afternoon Tea |
| | 17:30-19:30 | Dinner |
| | . . . | . . . |
| User 2 | 9:00-10:00 | Breakfast |
| | 14:00-15:00 | Lunch |
| | 19:00-21:00 | Dinner |

After the database mentioned above is established according to rules of the daily schedules of different users, special data entries corresponding to the user may be queried for in the database when it is detected that a user performs a browsing behavior that satisfies the first characteristic. It will determine information about the current living scenario of the user. Assuming that it is detected at 15:00 in the afternoon that user 1 and user 2 both perform continuous browsing behaviors, information about the living scenario corresponding to user 1 is afternoon tea, and information about the living scenario corresponding to user 2 is lunch.

The information about the daily schedules of the users may specifically be acquired in various manners. For example, a corresponding operation entry such as an input box may be provided to the user. The user enters the information by himself or herself. In some embodiments, information about the daily schedules of the users may be acquired by analyzing the text of chatting records of the users in a tool, such as an instant messaging tool, associated with the transaction platform.

In another implementation, the current living scenario of the user may alternatively be determined according to location information of the user. In a specific implementation, correspondence between places, information about geographical regions, and information about living scenarios may be established in advance. In this way, if it is found that a user performs a browsing behavior that satisfies the first characteristic, information about the geographical location of the user may be acquired. The method may then compare the acquired information about the geographical location of the user with pre-acquired information about geographical regions of places (for example, gym, library, and so on). If it is found that the user is located within a geographical region to which a particular place belongs, it may be determined that the user is located at this place. Correspondingly, since the correspondence between places and information about corresponding living scenarios is also established in advance, the information about the current living scenario of the user may further be determined according to the place where the user is current located. For example, as shown in Table 4:

TABLE 4

| Place | Information about Living Scenarios |
|---|---|
| A Gym | Fitness |
| A Beauty Salon | Cosmetology |
| A Barbershop | Hair Cut |
| . . . | . . . |

The information about the geographical location of the user may be obtained in various manners. For example, when a user accesses a transaction platform using a mobile terminal device, the information about the geographical location of the user may be acquired according to the positioning system in the mobile terminal apparatus because the mobile terminal device is generally equipped with a positioning system.

S104: Determine information about target commodities associated with the information about the living scenario.

After the information about the current living scenario of the user is acquired, information about target commodities associated with the information about the living scenario may be determined according to the correspondence recorded in Table 1.

S105: Provide the determined information about the target commodities to the user.

After the information about the associated target commodities is determined, the information about the target commodities may be recommended to the user. When the information about the target commodities is provided to the user, the information about the target commodities may be provided to individual client. The client may present or play the information to the user accordingly.

In practical applications, when recommended information about target commodities is provided to the user, factors such as time and location may further be taken into consideration. For example, after the living scenario of the user is determined according to the time point, information about target commodities related to the current geographical location of the user may be acquired from target commodities under the category associated with the living scenario, and provided to the user. For example, at lunch time, in general, information about restaurant services or resources may be recommended to the user. In this case, the information about the current location of the user may further be taken into consideration. Accordingly, information about restaurant services or resources near the location of the user may be recommended to the user. Such information is useful to the user. For example, when it is found at lunch time that a user performs a browsing behavior that satisfies the first characteristic and the acquired location of the user belongs to the Jianguomen area, information about restaurant services or resources near the Jianguomen area may be provided to the user. As the user usually chooses to have lunch in a restaurant nearby, such recommended information is of greater value to the user. In this case, the correspondence recorded in Table 1 may further record correspondence between information about target commodities and information about geographical locations of the target commodities.

In addition, in the process of providing the recommended information, the preference information of the user, information about categories of target commodities that the user is interested in, may further be taken into consideration. For example, for group purchase services related to restaurants, this category may further include many subcategories, such as fast food, hotpot, and barbecue. Different users may have different preferences. Therefore, when the recommended information is provided to the user according to the determined information about the living scenario, information about target commodities associated with the living scenario may be recommended to the user according to the preference information of the user. In this way, the recommended information about the target commodities can better meet the actual demand of the user in the current living scenario. The probability of making a deal may be improved. The user may gain effective services or resources from the transaction platform. When the preference information of the user is acquired, the preference information of the user about the browsing preference of target commodities and about the purchase preference of target commodities in a specific living scenario may be determined. In addition, in this case, the correspondence recorded in Table 1 may further record category information of the target commodities.

Furthermore, in the process of providing the recommended information, the category of the target commodities that the user is browsing may further be taken into consideration. In this way, according to an association relationship between the category of the target commodities that the user is browsing and a preset category, recommended information about target commodities under the category associated with the living scenario can be provided to the user. The association relationship between categories may be preset according to experience or the like. For example, a user has been browsing under the category of Female Dress for a long time. When it is time for afternoon tea, target commodities to be recommended may be desserts or the like under the category of afternoon tea. The reason is as follows: because the user has been browsing under the category of Female Dress for a long time, it usually indicates that the user is a female. As a lot of females are probably interested in desserts for afternoon tea, information about target commodities under the category of desserts may be preferentially recommended to the user.

In a specific implementation, in the process of providing recommended information about target commodities to the user, the determined information about the current living scenario may further be provided to the user. For example, a dialog box is presented on the user interface to show “It's time for dinner.” A control such as a button may further be set in the interface to show text such as “I know,” and the dialog box will not be closed until the user clicks or taps the button. In this way, the user will pay more attention to the recommended information. Accordingly, the effect of reminding is enhanced.

To sum up, through this embodiment of the present application, browsing behaviors of a user in a transaction platform may be monitored. When it is detected that a browsing behavior satisfies a first characteristic, information about the living scenario of the user may further be acquired. Accordingly, information about target commodities associated with the information about the living scenario is recommended to the user. In this way, on one hand, the user is freed from the previous browsing behavior and can relax the attention. On the other hand, since the recommended information is closely related to the actual living scenario of the user, an effect of reminding the user of daily schedule is also achieved. From the perspective of the transaction platform, there is a high probability that the user makes a deal because the recommended information is useful to the user. In other words, the probability of effectively utilizing services or resources in the transaction platform is increased.

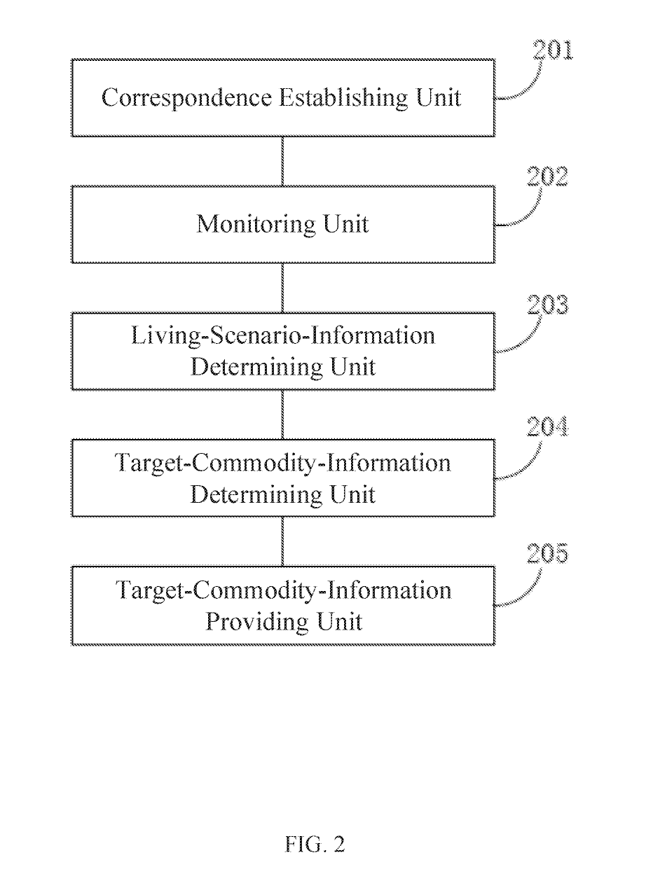

Corresponding to the method for providing information about target commodities according to the embodiments of the present application, an embodiment of the present application further provides an apparatus for providing information about target commodities. Referring to FIG. 2, the apparatus may include:

a correspondence establishing unit 201 establishing in advance correspondence between information about living scenarios and associated target commodities;

a monitoring unit 202 monitoring a browsing behavior of a user;

a living-scenario-information determining unit 203 determining information about a living scenario of the user when the monitored browsing behavior satisfies a first characteristic;

a target-commodity-information determining unit 204 determining information about target commodities associated with the information about the living scenario; and

a target-commodity-information providing unit 205 providing the determined information about the target commodities to the user.

The first characteristic includes at least one or any combination of the following characteristics of browsing behaviors:

an accumulated time of a browsing behavior of the user starting from a particular start time point exceeds a first time threshold;

a time length of a continuous browsing behavior of the user exceeds the first time threshold; or

a time length of a browsing behavior of the user on at least one specified website exceeds the first time threshold.

The information about the living scenario may specifically be acquired by various methods. For example, in an implementation, the apparatus may further establish in advance correspondence between information about living scenarios and time slots;

In this case, the living-scenario-information determining unit 203 may be specifically configured to:

acquire information about the current time point, and if the current time point falls within a particular time slot, determine information about a living scenario corresponding to the time slot as the information about the living scenario of the user.

In a specific implementation, the apparatus may further include:

a daily-schedule recording unit recording in advance information about daily schedule of the user. In this way, the correspondence between the information about the living scenarios and the time slots may be established according to the information about the daily schedule of the user.

To enable the recommended information to meet better the demands of the user, the correspondence established in advance between the information about the living scenarios and the associated target commodities may further include information about geographical locations of the target commodities. The apparatus may further include:

a geographical-location-information acquiring unit acquiring information about the current geographical location of the user.

The target-commodity-information determining unit 204 may be specifically configured to:

acquire information about target commodities related to the current geographical location of the user from the target commodities associated with the living scenario, and provide the information to the user.

In another implementation, correspondence between places, information about geographical regions, and information about living scenarios may further be established in advance. In this case, the living-scenario-information determining unit 203 may be specifically configured to:

acquire information about the current geographical location, and if the current geographical location is located within a geographical region to which the particular place belongs, determine the information about the living scenario corresponding to the particular place as the information about the living scenario of the user.

In a specific implementation, the correspondence established in advance between the information about the living scenarios and the associated target commodities may further include information about categories of the target commodities. The apparatus may further include:

a preference-information acquiring unit determining preference information of the user in the living scenario. The preference information may include information about categories of target commodities.

The target-commodity-information determining unit 204 is specifically configured to:

determine the information about the target commodities associated with the information about the living scenario and corresponding to the category information in accordance with the consuming preference information.

The preference-information acquiring unit may be specifically configured to: determine the preference information of the user about the browsing preference of target commodities and/or the purchase preference of target commodities in the living scenario.

In practical applications, to remind the user more effectively, the apparatus may further include:

a living-scenario-information providing unit providing the determined information about the living scenario to the user after determining the information about the living scenario of the user.

In summary, through this embodiment of the present application, a browsing behavior of a user in a transaction platform may be monitored. When it is detected that the browsing behavior satisfies a first characteristic, information about the living scenario of the user may further be acquired. The information about target commodities associated with the information about the living scenario is recommended to the user. In this way, on one hand, the user is freed from the previous browsing behavior and can relax the attention. On the other hand, since the recommended information is closely related to a stored living scenario of the user, an effect of reminding the user of normal daily schedule is also achieved. From the perspective of the transaction platform, there is a high probability that the user makes a deal because the recommended information is useful to the user. In other words, the probability of effectively utilizing services or resources in the transaction platform is increased.

According to the descriptions of the preceding embodiments, those skilled in the art may be clear that the present application can be implemented by means of software and a general hardware platform. Based on such an understanding, the technical solutions in the present application, the contribution to existing technologies, may be implemented in the form of a software product. The computer software product may be stored in a storage medium, such as a ROM/RAM, a magnetic disk, or an optical disc. The computer software product may include several instructions for instructing a computer apparatus (which may be a personal computer, a server, a network apparatus, or the like) to perform the method described in the embodiments of the present application or some parts of the embodiments of the present application.

The embodiments in the specification are described in a progressive manner. For same or similar parts in the embodiments, reference may be made to each other. Each embodiment focuses on differences from other embodiments. In particular, the system or system embodiment is basically similar to the method embodiment and therefore is described briefly. For the relevant part, reference may be made to the part of the description of the method embodiment. The system or system embodiment described above is merely exemplary. The units described as separate parts may or may not be physically separated. The parts shown as units may or may not be physical units, and may be located in one position or may be distributed on multiple network units. Some or all of the units may be selected according to actual needs to achieve the objectives of the solutions of the embodiments. Those of ordinary skill in the art can understand and implement the embodiments without creative efforts.

The methods and apparatuses for providing information about target commodities provided by the present application are described in detail above. Specific examples are used in the descriptions to elaborate the principle and implementation of the present application. However, the descriptions of the preceding embodiments are merely used to facilitate understanding of the methods and main ideas of the present application. Those of ordinary skill in the art can make modifications to the specific implementations and the application scope according to the ideas of the present application. Therefore, the content of the specification should not be construed as limit to the present application.

1. A method for providing information about target commodities, the method comprising:
establishing in advance correspondence between information about stored living scenarios and associated target commodities;
monitoring a browsing behavior of a user;
determining information about a stored living scenario of the user when the monitored browsing behavior satisfies a first characteristic;
determining information about target commodities associated with the information about the stored living scenario; and
providing the determined information about the target commodities to the user.

2. The method of claim 1,
wherein the first characteristic includes at least one or any combination of the following characteristics of browsing behaviors:
an accumulated time of a browsing behavior of the user starting from a particular start time point exceeds a first time threshold;
a time length of a continuous browsing behavior of the user exceeds the first time threshold; or
a time length of a browsing behavior of the user on at least one specified website exceeds the first time threshold.

3. The method of claim 1, further comprising:
establishing in advance correspondence between information about stored living scenarios and time slots,
wherein determining the information about the stored living scenario of the user includes:
acquiring information about current time point; and
when the current time point falls within a time slot, determining information about a stored living scenario corresponding to the time slot as the information about the stored living scenario of the user.

4. The method of claim 3, further comprising:
recording in advance information about daily schedule of the user,
wherein establishing in advance the correspondence between the information about the stored living scenarios and the time slots includes:
establishing the correspondence between the information about the stored living scenarios and the time slots in accordance with the information about the daily schedule of the user.

5. The method of claim 1,
wherein the correspondence established in advance between the information about the stored living scenarios and the associated target commodities further includes:
information about geographical locations of the target commodities,
wherein the method further comprises:
acquiring information about the current geographical location of the user, and
wherein determining the information of the target commodities associated with the information about the stored living scenario includes:
acquiring target commodities related to the current geographical location of the user from the target commodities associated with the stored living scenario.

6. The method of claim 1, further comprising:
establishing in advance correspondence between places, information about geographical regions, and information about stored living scenarios,
wherein determining the information about the stored living scenario of the user includes:
acquiring information about the current geographical location of the user, and
when the current geographical location is located within a geographical region to which a particular place belongs, determining information about the stored living scenario corresponding to the particular place as the information about the stored living scenario of the user.

7. The method of claim 1,
wherein the associated target commodities in the correspondence established in advance between the information about the stored living scenarios and the associated target commodities further includes:
category information of the target commodities,
wherein the method further comprises:
determining preference information of the user in the stored living scenario, wherein the preference information includes category information of target commodities, and
wherein determining the information about the target commodities associated with the information about the stored living scenario includes:
determining the information about the target commodities associated with the information about the stored living scenario and corresponding to the category information in accordance with the consuming preference information.

8. The method of claim 7, wherein determining the preference information of the user in the stored living scenario includes:
determining the preference information of the user about at least one of the browsing preference of target commodities or the purchase preference of target commodities in the stored living scenario.

9. The method of claim 1, further comprising:
providing the determined information about the stored living scenario to the user after determining the information about the stored living scenario of the user.

10. An apparatus for providing information about target commodities, the apparatus comprising:
a correspondence establishing unit that establishes in advance correspondence between information about stored living scenarios and associated target commodities;
a monitoring unit that monitors a browsing behavior of a user;
a living-scenario-information determining unit that determines information about a stored living scenario of the user when the monitored browsing behavior satisfies a first characteristic;
a target-commodity-information determining unit that determines information about target commodities associated with the information about the stored living scenario; and
a target-commodity-information providing unit that provides the determined information about the target commodities to the user.

11. The apparatus of claim 10, further comprising:
a daily-schedule recording unit that records in advance information about daily schedule of the user.

12. The apparatus of claim 10, further comprising:
a geographical-location-information acquiring unit that acquires information about the current geographical location of the user,
wherein the target-commodity-information determining unit further acquires information about target commodities related to the current geographical location of the user from the target commodities associated with the stored living scenario.

13. The apparatus of claim 10, further comprising:
a preference-information acquiring unit that determines preference information of the user in the stored living scenario,
wherein the target-commodity-information determining unit further determines the information about the target commodities associated with the information about the stored living scenario and corresponding to the category information in accordance with the consuming preference information.

14. The apparatus of claim 10, further comprising:
a living-scenario-information providing unit that provides the determined information about the stored living scenario to the user after determining the information about the stored living scenario of the user.

15. A non-transitory computer readable medium that stores a set of instructions that is executable by at least one processor of an apparatus to cause the apparatus to perform a method for storing data, the method comprising:
establishing in advance correspondence between information about stored living scenarios and associated target commodities;
monitoring a browsing behavior of a user;
determining information about a stored living scenario of the user when the monitored browsing behavior satisfies a first characteristic;
determining information about target commodities associated with the information about the stored living scenario; and
providing the determined information about the target commodities to the user.

16. The non-transitory computer-readable medium of claim 15, wherein the set of instructions that is executable by the at least one processor of the apparatus to cause the apparatus to further perform:
establishing in advance correspondence between information about stored living scenarios and time slots,
wherein determining the information about the stored living scenario of the user includes:
acquiring information about current time point; and
when the current time point falls within a time slot, determining information about a stored living scenario corresponding to the time slot as the information about the stored living scenario of the user.

17. The non-transitory computer-readable medium of claim 16, wherein the set of instructions that is executable by the at least one processor of the apparatus to cause the apparatus to further perform:
recording in advance information about daily schedule of the user,
wherein establishing in advance the correspondence between the information about the stored living scenarios and the time slots includes:
establishing the correspondence between the information about the stored living scenarios and the time slots in accordance with the information about the daily schedule of the user.

18. The non-transitory computer-readable medium of claim 15,
wherein the correspondence established in advance between the information about the stored living scenarios and the associated target commodities further includes:
information about geographical locations of the target commodities,
wherein the set of instructions that is executable by the at least one processor of the apparatus to cause the apparatus to further perform:
acquiring information about the current geographical location of the user, and
wherein determining the information of the target commodities associated with the information about the stored living scenario includes:
acquiring target commodities related to the current geographical location of the user from the target commodities associated with the stored living scenario.

19. The non-transitory computer-readable medium of claim 15, wherein the set of instructions that is executable by the at least one processor of the apparatus to cause the apparatus to further perform:
establishing in advance correspondence between places, information about geographical regions, and information about stored living scenarios,
wherein determining the information about the stored living scenario of the user includes:
acquiring information about the current geographical location of the user, and
when the current geographical location is located within a geographical region to which a particular place belongs, determining information about the stored living scenario corresponding to the particular place as the information about the stored living scenario of the user.

20. The non-transitory computer-readable medium of claim 15,
wherein the associated target commodities in the correspondence established in advance between the information about the stored living scenarios and the associated target commodities further includes:
category information of the target commodities,
wherein the set of instructions that is executable by the at least one processor of the apparatus to cause the apparatus to further perform:
determining preference information of the user in the stored living scenario, wherein the preference information includes category information of target commodities, and
wherein determining the information about the target commodities associated with the information about the stored living scenario includes:
determining the information about the target commodities associated with the information about the stored living scenario and corresponding to the category information in accordance with the consuming preference information.
